(19) United States
(12) Patent Application Publication
(10) Pub. No.: US 2015/0142322 A1
(43) Pub. Date: May 21, 2015

(54) VIBRATION INFORMATION GATHERING METHOD AND VIBRATION INFORMATION GATHERING APPARATUS

(71) Applicant: Seiko Epson Corporation, Tokyo (JP)

(72) Inventors: Hiroshi OKAMOTO, Minamiminowa (JP); Tomoyuki KURATA, Matsumoto (JP)

(21) Appl. No.: 14/546,535

(22) Filed: Nov. 18, 2014

(30) Foreign Application Priority Data
Nov. 19, 2013 (JP) 2013-238590

(51) Int. Cl. G01V 1/00

(52) U.S. Cl. CPC G01V 1/008
USPC 702/15

(57) ABSTRACT

A vibration information gathering method includes: gathering output data about information of a vibration of a structure; and selecting at least one of an average value, a maximum value and a minimum value from the output data that is gathered.

### BACKGROUND

1. Technical Field

The present invention relates to a vibration information gathering method and a vibration information gathering apparatus.

2. Related Art

Recently, there is a growing public awareness of disaster prevention and interest in safety of structures in the case of earthquakes. Thus, as a device for detecting a vibration of a structure or the like, a detection device equipped with a sensor or the like is used.

According to JP-A-2000-149104, a network is formed by vending machines located in various places. Each vending machine is provided with a seismic intensity detection unit. When an earthquake occurs, information of seismic intensity data or the like gathered by each vending machine can be browsed via the network.

However, according to JP-A-2000-149104, since each vending machine constantly gathers information, an enormous amount of information is gathered as a result. Moreover, as the vending machine saves the gathered information in a storage unit, the recording capacity of the storage unit is strained due to the enormous amount of information, thus resulting in a problem of hampering the gathering of new information. Also, when a terminal is connected to the vending machine via the network in order to browse the information gathered by the vending machine, there is a problem of communication failure due to an overload on the network caused by the enormousness of the amount of information.

### SUMMARY

An advantage of some aspects of the invention is to solve at least a part of the problems described above, and the invention can be implemented as the following forms or application examples.

### APPLICATION EXAMPLE 1

This application example is directed to a vibration information gathering method including receiving output data outputted from a measurement device which measures a vibration of a structure, selecting the output data on the basis of a determination condition, and transmitting the selected output data to a server. According to an embodiment, the method may include gathering output data about information of a vibration of a structure, and selecting at least one of an average value, a maximum value and a minimum value from the gathered output data.

A vibration processing device used in such a vibration information gathering method can receive output data outputted from a measurement device which measures a vibration of a structure, and select necessary output data from the output data, as select data, according to a preset determination condition. Thus, select data with a reduced data volume from the output data can be provided. Therefore, the straining of the storage unit recording the select data, and the communication failure due to an increase in load on the communication network or the like at the time of transmitting the select data to the server can be restrained.

### APPLICATION EXAMPLE 2

In the vibration information gathering method according to the application example described above, based on the determination condition, at least one of an average value, a maximum value and a minimum value of the output data is selected.

### APPLICATION EXAMPLE 3

In the vibration information gathering method according to the application example described above, based on the determination condition, an average value of the output data is selected if the output data is equal to or below a threshold.

### APPLICATION EXAMPLE 4

In the vibration information gathering method according to the application example described above, based on the determination condition, at least one of a maximum value and a minimum value of the output data is selected if the output data exceeds the threshold value.

According to such configurations, either the average value of the output data outputted from the measurement device to the vibration processing device, or at least one of the maximum value of the output data and the minimum value of the output data, can be selected as select data on the basis of the determination condition. The case where the average value of the output data is selected as select data is when the output data is determined as being in the range equal to or below the predetermined threshold. The case where at least one of the maximum value of the output data and the minimum value of the output data is selected as select data is when the output data is determined as being in the range exceeding the predetermined threshold. Thus, select data with a reduced data volume from the output data can be provided. Therefore, the straining of the storage unit recording the select data, and the communication failure due to an increase in load on the communication network or the like at the time of transmitting the select data to the server can be restrained.

### APPLICATION EXAMPLE 5

This application example is directed to a vibration information gathering apparatus including a receiving unit which receives output data outputted from a measurement device measuring a vibration of a structure, a selection unit which selects the output data on the basis of a determination condition, and a transmission unit which transmits the selected output data to a server.

A vibration processing device of such a vibration information gathering apparatus includes a receiving unit which receives output data outputted from a measurement device measuring a vibration of a structure, a selection unit which selects data to be selected from the output data received on the basis of a preset determination condition, and a transmission unit which transmits the select data to a server. Thus, the selection unit provides select data with a reduced data volume from the output data. Therefore, the straining of the storage unit recording the select data, and the communication failure due to an increase in load on the communication network or the like at the time of transmitting the select data to the server can be restrained.

### APPLICATION EXAMPLE 6

In the vibration information gathering apparatus according to the application example described above, the measurement device is provided on the structure.

According to the vibration information gathering apparatus of this configuration, a measurement device which measures a vibration is provided at a predetermined position on the structure. As the vibration status or the like of the structure is grasped and output data outputted from the measurement device is analyzed, the result of analysis can be used for structural health monitoring (SHM) of the structure. Thus, the health and capability of the structure can be securely monitored.

### APPLICATION EXAMPLE 7

In the vibration information gathering apparatus according to the application example described above, the vibration processing device periodically transmits information other than the output data to the server and transmits the selected output data to the server at the time of this transmission.

According to the vibration information gathering apparatus of this application example, the vibration processing device may transmit select data to the server simultaneously at the time of periodically transmitting information other than the output data. As the select data is transmitted to the server simultaneously at the time of data communication such as regular contact, the time taken in the transmission can be restrained.

### APPLICATION EXAMPLE 8

In the vibration information gathering apparatus according to the application example described above, the selected output data includes unique information of the measurement device.

According to the vibration information gathering apparatus of this application example, as the unique information of the measurement device is included in the select data, the vibration processing device can acquire position information or the like of the measurement device on the basis of the unique information. A database related to the unique information of the measurement device may be arranged in the server and the unique information of the measurement device included in the select data and the unique information stored in the database may be compared with each other, thus grasping the position information and state of the measurement device.

### APPLICATION EXAMPLE 9

This application example is directed to a fixed device including a wireless communication unit which transmits an output from the vibration information gathering apparatus to the server.

According to such a fixed device, the vibration information gathering apparatus can transmit and receive vibration information via wireless communication to and from the measurement device and the server, utilizing the wireless communication unit of the fixed device. Thus, the laying of wires within the structure where the vibration information gathering apparatus is provided can be obviated and the breaking of wires or the like due to accidents can be avoided.

### BRIEF DESCRIPTION OF THE DRAWINGS

The invention will be described with reference to the accompanying drawings, wherein like numbers reference like elements.

FIGS. 1A and 1B show examples of the configuration of a vibration information gathering apparatus according to a first embodiment.

FIG. 2 shows an example of the configuration of a measurement device or a vibration processing device according to the first embodiment.

FIGS. 3A to 3C show an example of the arrangement of select data according to the first embodiment.

FIG. 4 shows the configuration of a server according to the first embodiment.

FIG. 5 is a flowchart showing an example of processing by the vibration information gathering apparatus according to the first embodiment.

FIG. 6 is a flowchart showing an example of processing by the measurement device according to the first embodiment.

FIG. 7 is a flowchart showing an example of processing by the vibration processing device according to the first embodiment.

FIG. 8 is a flowchart showing an example of processing by the server according to the first embodiment.

FIG. 9 shows an example of the configuration of a vibration information gathering apparatus according to a second embodiment.

FIG. 10 is a flowchart showing an example of processing by the vibration information gathering apparatus according to the second embodiment.

FIG. 11 is a flowchart showing an example of processing by a measurement device according to the second embodiment.

FIG. 12 is a flowchart showing an example of processing by a server according to the second embodiment.

FIG. 13 shows an example of the configuration of a vibration information gathering apparatus according to a third embodiment.

FIG. 14 shows an example of output data according to the third embodiment.

FIG. 15A is a plan view showing an example of the configuration of a vibration sensor. FIG. 15B is a cross-sectional view showing an example of the configuration of a physical quantity detection device.

FIG. 16 is a perspective view showing a mobile phone as an electronic device equipped with a measurement device or a vibration processing device.

FIG. 17 is a perspective view showing a vending machine equipped with a measurement device or a vibration processing device.

### DESCRIPTION OF EXEMPLARY EMBODIMENTS

Hereinafter, embodiments of the invention will be described with reference to the drawings. In the following drawings, the scales of respective layers and members are different from the actual scales thereof in order to draw the respective layers and members in recognizable sizes. Also, the embodiments are solely examples. Apart of the components (respective parts) may be omitted or some components may be added.

### First Embodiment

### Outline of Vibration Information Gathering Apparatus

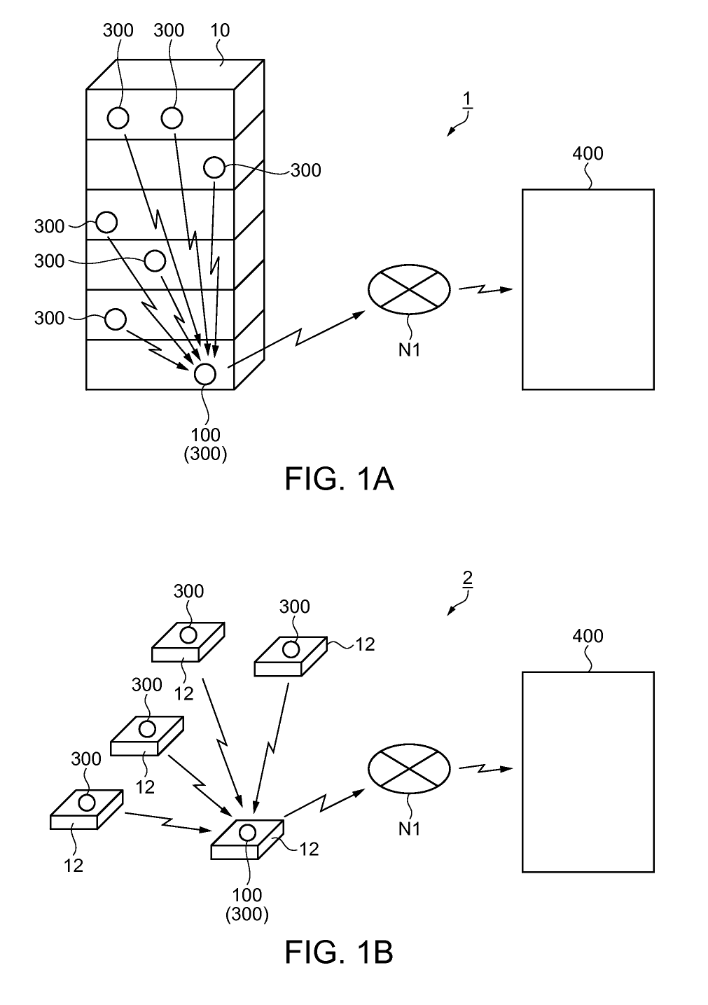

FIGS. 1A and 1B show examples of the configuration of a vibration information gathering apparatus according to this embodiment.

The configuration of a vibration information gathering apparatus 1 according to this embodiment will be described with reference to FIGS. 1A and 1B.

The vibration information gathering apparatus 1 of this embodiment includes a vibration processing device 100, plural measurement devices 300, a server 400, and a communication network N1.

The plural measurement devices 300 are capable of communicating via a multi-hop wireless network or the like and transmitting and receiving data.

The vibration processing device 100 gathers data (output data) that is obtained and outputted as the vibration processing device 100 and the measurement devices 300 constantly measure a vibration, and the vibration processing device 100 transmits data (select data) obtained as a result of predetermined processing on the output data, to the server 400 via the communication network N1.

The vibration processing device 100 and the measurement devices 300 have similar structures and are arranged in a structure 10 or a structure 12, as will be described below. One of the measurement devices 300 can function as the vibration processing device 100 in response to a command received from the server 400 via the communication network N1 or according to the setting of the measurement devices 300.

For example, if a certain inconvenience occurs in the vibration processing device 100, communication can be carried out via the multi-hop wireless network so as to cause one of the measurement devices 300 to function as a substitute for the vibration processing device 100.

The communication network N1 is realized by a wireless communication network, a dedicated network, a wide LAN, the Internet, or the like. As wireless communication (communication network N1 and multi-hop wireless network) is used, the laying of wires at the time of arranging the vibration processing device 100 and the measurement devices 300 within the structure can be obviated and the breaking of wires or the like due to accidents and disasters can be avoided.

It should be noted that while the multi-hop wireless network is used in this embodiment, this network may be replaced by networks using other wireless communication systems.

In the vibration information gathering apparatus 1 of this embodiment, the plural measurement devices 300 and the vibration processing device 100 are arranged at plural positions in the structure 10, as shown in FIG. 1A. Here, the structure 10 is a high-rise building or super high-rise building.

The plural measurement devices 300 and the vibration processing device 100 constantly measure a vibration of the structure 10. Output data outputted in this measurement is gathered by the vibration processing device 100. The vibration processing device 100 selects select data from the gathered output data. Then, the vibration processing device 100 transmits the select data to the server 400 via the communication network N1. The server 400 carries out predetermined processing on the received select data and thus can obtain the distribution of a vibration of the structure 10 where the plural measurement devices 300 are arranged.

The measurement devices 300 may be arranged on each floor of the structure 10 and may be arranged densely or sparsely depending on the floor. For example, on upper floors, the measurement devices 300 may be arranged at a high density, whereas on the other floors, the measurement devices 300 may be arranged at a lower density. Thus, the influence on the structure 10 of a vibration generated by an earthquake can be analyzed.

Meanwhile, in a vibration information gathering apparatus 2, plural measurement devices 300 are arranged in plural structures 12 at predetermined intervals, as shown in FIG. 1B. Here, the structures 12 are fixed devices such as vending machines, hydrants, traffic signals, utility poles, telephone poles, and gas meters.

The measurement devices 300 may not be arranged at a uniform density and may be arranged densely or sparsely depending on the place. For example, in urban and surrounding areas, the measurement devices 300 may be arranged at a high density, whereas in other places, the measurement devices 300 may be arranged at a lower density.

Thus, by analyzing a vibration measured by the measurement devices 300, it is possible to analyze a vibration on the occurrence of an earthquake. By analyzing the a vibration, it is possible to acquire earthquake information such as seismic intensity in the places where the measurement devices 300 are arranged. Based on the earthquake information, isoseismic lines can be drawn on a map (not shown) and the distribution of seismic intensity can be acquired, which can be utilized for grasping evacuation routes incase of disasters. Isoseismic lines refer to line segments that connect the measurement devices 300 acquiring the same seismic intensity, in a circular form.

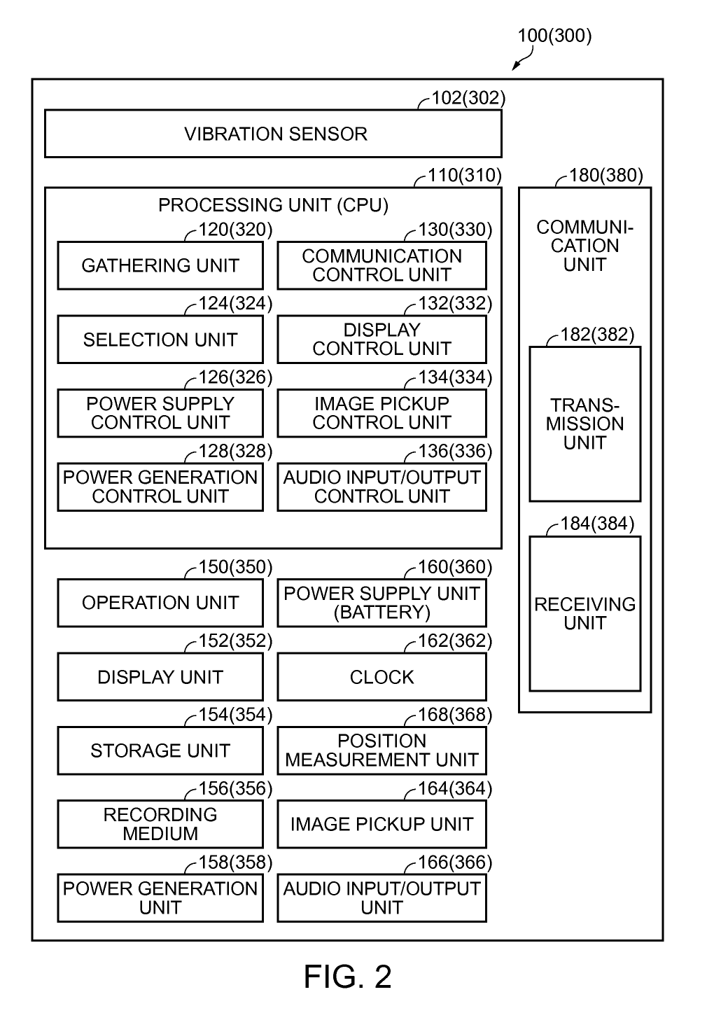

The configuration of the measurement devices 300 and the vibration processing device 100 of this embodiment will be described with reference to FIG. 2. FIG. 2 shows an example of the configuration of the measurement device or the vibration processing device of this embodiment.

### Configuration of Measurement Device

The measurement device 300 includes a processing unit (CPU: central processing unit) 310, a vibration sensor 302, an operation unit 350, a display unit 352, a storage unit 354, a recording medium 356, a power generation unit 358, a power supply unit 360, a clock 362, an image pickup unit 364, an audio input/output unit 366, a position measurement unit 368, and a communication unit 380.

The measurement device 300 of this embodiment is an example. A part of the components (respective parts) may be omitted or some components may be added.

The vibration sensor 302 measures a vibration at the position where the measurement device 300 is provided.

In this embodiment, the vibration sensor 302 uses a three-axis vibration sensor and is capable of detecting a vibration in x-axis, y-axis and z-axis directions as three axes orthogonal to each other.

The operation unit 350 is an input device made up of operation keys and button switches or the like and outputs an operation signal to the processing unit 310.

The display unit 352 is a display device made up of an LCD (liquid crystal display) or the like and displays various kinds of information based on a display signal inputted from the processing unit 310.

The storage unit 354 stores programs and data or the like for the processing unit 310 to carry out various kinds of calculation processing and control processing. The storage unit 354 is also used as a work area for the processing unit 310 and used for temporarily storing data inputted from the operation unit 350, programs and data read out from the recording medium 356, the results of arithmetic operations executed by the processing unit 310 according to various programs, and the like.

The recording medium 356 includes an optical disc (CD, DVD), magneto-optical disc (MO), magnetic disc, hard disk, magnetic tape, memory (ROM, flash memory or the like), or the like.

The power generation unit 358 converts at least one of light, heat, wind, and vibration to electrical energy on the basis of a power generation signal inputted from the processing unit 310, and thus generates electric power.

The power supply unit 360 is a rechargeable battery, which manages the power supply on the basis of a power supply signal inputted from the processing unit 310.

The clock 362 measures precise time on the basis of time information received by a radio-controlled clock (not shown).

The image pickup unit 364 is a camera, which picks up an image of the surrounding circumstance of the measurement device 300 on the basis of an image pickup signal inputted from the processing unit 310. The picked-up image or the like may be saved in the storage unit 354 or the recording medium 356.

The audio input/output unit 366 is a microphone and speaker, and gathers sounds via the microphone and outputs a sound from the speaker, on the basis of an audio input/output signal inputted from the processing unit 310. The sounds gathered via the microphone may be saved in the storage unit 354 and the recording medium 356 as audio data. Also, audio data saved in the storage unit 354 and the recording medium 356 may be outputted as a sound from the speaker.

The position measurement unit 368 includes one of a positioning system such as the GPS, a positioning system which recognizes a position, using radio wave information transmitted from a Wi-Fi access point of a wireless LAN or the like, and a positioning system which recognizes a position, using radio wave information transmitted from a base station for mobile phones or the like. The position measurement unit 368 thus measures the position of the measurement device 300.

The communication unit 380 includes a transmission unit 382 and a receiving unit 384 and carries out wireless communication with the vibration processing device 100 and the other measurement devices 300 on the basis of a communication signal inputted from the processing unit 310. While wireless communication is used in this embodiment, wired communication may also be used.

In the case where the measurement device 300 is arranged in the structure 12 (see FIG. 1B), which is a fixed device provided with a wireless communication unit, the wireless communication unit provided in the fixed device can be used for communication.

The processing unit 310 includes a gathering unit 320, a selection unit 324, a power supply control unit 326, a power generation control unit 328, a communication control unit 330, a display control unit 332, an image pickup control unit 334, and an audio input/output control unit 336, and carries out various kinds of calculations and control processing according to programs stored in the storage unit 354 and the recording medium 356.

Specifically, the processing unit 310 acquires vibration data measured by the vibration sensor 302 and saves the vibration data in the gathering unit 320, the storage unit 354 or the recording medium 356 or the like. The vibration data or the like that is acquired and saved can also be selected by the selection unit 324, described later.

The processing unit 310 may also carry out various kinds of processing according to operation signals from the operation unit 350, processing to cause the display unit 352 to display various kinds of information, and processing to transmit vibration data or the like to another communication unit (not shown) via the communication unit 380.

Here, the vibration data refers to data that is acquired by measuring a vibration for a predetermined period with the vibration sensor 302.

The gathering unit 320 acquires and saves the vibration data or the like measured by the vibration sensor 302. The acquired vibration data and the time when the measurement of a vibration is started, measured by the clock 362, are saved in one of the gathering unit 320, the storage unit 354 and the recording medium 356. Also, the gathering unit 320 has a determination function and carries out determination processing to determine whether the measurement time exceeds a predetermined time or not. The gathering unit 320 also carries out an arithmetic operation of the acquired vibration data.

The selection unit 324 converts the vibration data acquired by the gathering unit 320 and thus creates output data.

The output data is provided with an ID (identification) number, which is unique information to identify the measurement device 300. Even if the output data is transmitted to another communication unit (not shown), the output data can be discriminated on the basis of the ID number. The ID number is recorded in the server 400 as the position information of the measurement device 300. For example, if the position registered with the ID number is different from the position measured by the position measurement unit 368, it is assumed that the measurement device 300 is shifted by the influence of a vibration, and the magnitude of the a vibration can be estimated.

The power supply control unit 326 controls the power supply that causes the measurement device 300 to operate. Normally, power is supplied from outside. However, if the supply is cut off, the power supply control unit 326 switches on the power supply unit 360 and thus maintains the operation of the measurement device 300. The power supply control unit 326 also carries out processing to acquire information such as the remaining battery capacity of the power supply unit 360.

The power generation control unit 328 controls the power generator of the power generation unit 358 and charges the battery of the power supply unit 360, when the remaining battery capacity of the power supply unit 360 is low.

The communication control unit 330 carries out processing to control communication between the communication unit 380, and the vibration processing device 100 and the other measurement devices 300 connected via wireless communication.

The display control unit 332 carries out processing to control the display on the display unit 352.

The image pickup control unit 334 carries out processing to control the image pickup by the image pickup unit 364.

The audio input/output control unit 336 carries out processing to control the audio input and output by the audio input/output unit 366.

### Configuration of Vibration Processing Device

The vibration processing device 100 has a similar configuration to the measurement device 300. Therefore, the configuration of the vibration processing device 100 will be described suitably according to need, but not in detail.

The vibration processing device 100 includes a processing unit 110, an operation unit 150, a display unit 152, a storage unit 154, a recording medium 156, a power generation unit 158, a power supply unit 160, a clock 162, an image pickup unit 164, an audio input/output unit 166, a position measurement unit 168, and a communication unit 180.

A vibration sensor 102 measures a vibration at the position where the vibration processing device 100 is provided.

The vibration sensor 102 is similar to the vibration sensor 302 and therefore will not be described further in detail.

The operation unit 150 is an input device made up of operation keys, button switches and the like and outputs an operation signal to the processing unit 110.

The display unit 152 is a display device made up of an LCD or the like and displays various kinds of information based on a display signal inputted from the processing unit 110.

The storage unit 154 stores programs and data or the like for the processing unit 110 to carry out various kinds of calculation processing and control processing. The storage unit 154 is also used as a work area for the processing unit 110 and used for temporarily storing data inputted from the operation unit 150, programs and data read out from the recording medium 156, and the results of arithmetic operations executed by the processing unit 110 according to various programs.

The recording medium 156 is similar to the recording medium 356 and therefore will not be described further in detail.

The power generation unit 158 converts at least one of light, heat, wind, and a vibration into electrical energy and thus generates power, on the basis of a power generation signal inputted from the processing unit 110.

The power supply unit 160 is a rechargeable battery, which manages the power supply on the basis of a power supply signal inputted from the processing unit 110.

The clock 162 is similar to the clock 362 and therefore will not be described further in detail.

The image pickup unit 164 is a camera, which picks up an image of the surrounding circumstance of the vibration processing device 100 on the basis of an image pickup signal inputted from the processing unit 110. The picked-up image or the like may be saved in the storage unit 154 or the recording medium 156.

The audio input/output unit 166 is a microphone and speaker, and gathers sounds via the microphone and outputs a sound from the speaker, on the basis of an audio input/output signal inputted from the processing unit 110. The sounds gathered via the microphone may be saved in the storage unit 154 and the recording medium 156 as audio data. Also, audio data saved in the storage unit 154 and the recording medium 156 may be outputted as a sound from the speaker.

The position measurement unit 168 includes one of a positioning system such as the GPS, a positioning system which recognizes a position, using radio wave information transmitted from a Wi-Fi access point of a wireless LAN or the like, and a positioning system which recognizes a position, using radio wave information transmitted from a base station for mobile phones or the like. The position measurement unit 168 thus measures the position of the vibration processing device 100.

The communication unit 180 includes a transmission unit 182 and a receiving unit 184 and carries out wireless communication with the measurement devices 300 and with the server 400 via the communication network N1 on the basis of a communication signal inputted from the processing unit 110. While wireless communication is used in this embodiment, wired communication may also be used.

In the case where the vibration processing device 100 is arranged in the structure 12 (see FIG. 1B), which is a fixed device provided with a wireless communication unit, the wireless communication unit provided in the fixed device can be used for communication.

The processing unit 110 includes a gathering unit 120, a selection unit 124, a power supply control unit 126, a power generation control unit 128, a communication control unit 130, a display control unit 132, an image pickup control unit 134, and an audio input/output control unit 136, and carries out various kinds of calculations and control processing according to programs stored in the storage unit 154 and the recording medium 156.

Specifically, the processing unit 110 acquires vibration data measured by the vibration sensor 102 and output data of the measurement devices 300 received via the communication unit 180, and saves these data in the gathering unit 120, the storage unit 154 or the recording medium 156 or the like. These output data or the like that is acquired and saved can also be selected by the selection unit 124, described later.

The processing unit 110 may also carry out various kinds of processing according to operation signals from the operation unit 150, processing to cause the display unit 152 to display various kinds of information, and processing to transmit data or the like to another communication unit (not shown) via the communication unit 180.

Here, the vibration data refers to data that is acquired by measuring a vibration for a predetermined period with the vibration sensor 102.

The gathering unit 120 acquires the output data outputted from the measurement devices 300, via the communication unit 180. The acquired output data and the time measured by the clock 162 are saved in either the storage unit 154 or the recording medium 156. Also, the gathering unit 120 has a determination function and carries out determination processing to determine whether the measurement time during which a vibration are measured exceeds a predetermined time or not. The gathering unit 120 also carries out an arithmetic operation of the acquired vibration data.

The selection unit 124 selects select data from the output data acquired by the gathering unit 120. The content of the select data will be described later.

The power supply control unit 126 controls the power supply that causes the vibration processing device 100 to operate. Normally, power is supplied from outside. However, if the supply is cut off, the power supply control unit 126 switches on the power supply unit 160 and thus maintains the operation of the vibration processing device 100. The power supply control unit 126 also carries out processing to acquire information such as the remaining battery capacity of the power supply unit 160.

The power generation control unit 128 controls the power generator of the power generation unit 158 and charges the battery of the power supply unit 160, when the remaining battery capacity of the power supply unit 160 is low.

The communication control unit 130 carries out processing to control communication carried out by the communication unit 180 with the measurement devices 300 and the server 400 connected via wireless communication.

The display control unit 132 carries out processing to control the display on the display unit 152.

The image pickup control unit 134 carries out processing to control the image pickup by the image pickup unit 164.

The audio input/output control unit 136 carries out processing to control the audio input and output by the audio input/output unit 166.

Now, the select data selected from the output data by the selection unit 124 will be described.

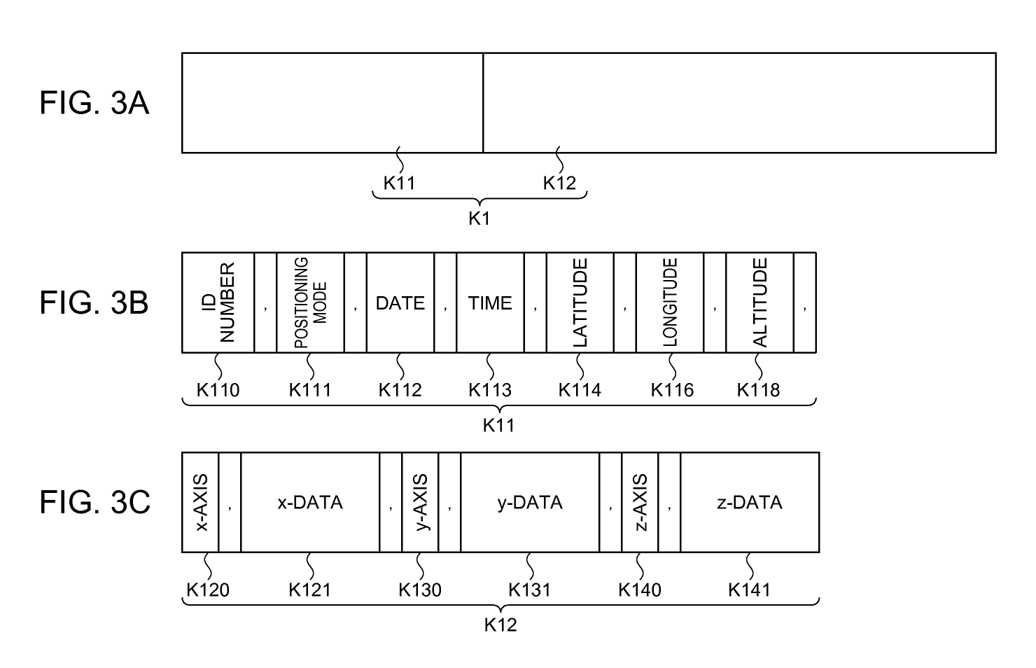

FIGS. 3A to 3C show an example of the arrangement of the select data selected by the selection unit 124. FIG. 3A shows the whole of the select data. FIG. 3B shows a header part of the select data. FIG. 3C shows a data part of the select data.

As shown in FIG. 3A, the whole K1 of the select data includes a header part K11 and a data part K12.

As shown in FIG. 3B, the header part K11 includes ID number K110, positioning mode K111, date K112, time K113, latitude K114, longitude K116, and altitude K118.

The ID number K110 is unique information to identify the measurement device 300. Specifically, the ID number as unique information of the measurement device 300 may be added to the select data, thus enabling discrimination of the select data of plural measurement devices 300.

The positioning mode K111 is the method used by the position measurement unit 368 of the measurement device 300 to measure the position. Specifically, “G” indicates a positioning system such as the GPS, “L” indicates a positioning system such as a wireless LAN, and “S” indicates a position system utilizing a base station for mobile phones or the like, as the method used to measure the position. “N” indicates the state where positioning is not available.

The date K112 indicates the date on which the position is measured by the position measurement unit 368 of the measurement device 300.

The time K113 indicates the time when the position is measured by the position measurement unit 368 of the measurement device 300.

The latitude K114 indicates the latitude measured by the position measurement unit 368.

The longitude K116 indicates the longitude measured by the position measurement unit 368.

The altitude K118 indicates the altitude measured by the position measurement unit 368 or an altimeter (not shown) or the like.

If position information is not added, the positioning mode K111, the latitude K114, the longitude K116 and the altitude K118 may be omitted.

As shown in FIG. 3C, the data part K12 includes x-axis K120, x-data K121, y-axis K130, y-data K131, z-axis K140, and z-data K141. The “x-axis”, “y-axis” and “z-axis” represent coordinate axes in the respective axial directions. The x-data, y-data and z-data represent select data determined and selected from output data by the selection unit 124 of the vibration processing device 100. As the select data, either an average value of the output data, or at least one of a maximum value of the output data and a minimum value of the output data is selected.

As the select data, “AVE” is added as the average value of the output data, “MAX” is added as the maximum value of the output data, and “MIN” is added as the minimum value of the output data.

Now, the select data of FIGS. 3A to 3C will be described, using specific select data.

The following is an example of select data selected from output data by the selection unit 124: “001, G, 20120808, 220514.00, N35.681382, E139.766084, 10.00m, x, MAX, 0.0100, y, MAX, 0.0150, MIN, 0.0002, z, AVE, 0.0010”.

The header part K11 includes the ID number K110, the positioning mode K111, the date K112, the time K113, and the position information (latitude K114, longitude K116 and altitude K118), as described above.

“001” of the select data represents ID number, indicating the ID number “001” (ID number K110).

“G” of the select data represents positioning mode, indicating that the position is measured by a positioning system such as the GPS (positioning mode K111).

“20120808” of the select data represents date, indicating Aug. 8, 2012 (date K112).

“220514.00” of the select data represents time, indicating 22 hours, 05 minutes, 14.00 seconds (22:05:14.00) (time K113).

“N35.681382” of the select data represents latitude, indicating 35.681382 degrees north (latitude K114).

“E139.766084” of the select data represents longitude, indicating 139.766084 degrees east (longitude K116).

“10.00m” of the select data represents altitude, indicating 10.00 meters (altitude K118).

The data part K12 is vibration data including the x-axis K120, the x-data K121, the y-axis K130, the y-data K131, the z-axis K140, and the z-data K141, as described above.

The part “x, MAX, 0.0100” of the select data indicates the maximum value 0.0100 of the output data on the x-axis (x-axis K120, x-data K121).

The part “y, MAX, 0.0150, MIN, 0.0002” of the select data indicates the maximum value 0.0150 of the output data on the y-axis and the minimum value 0.0002 of the output data on the y-axis (y-axis K130, y-data K131).

The part “z, AVE, 0.0010” indicates the average value 0.0010 of the output data on the z-axis (z-axis K140, z-data K141).

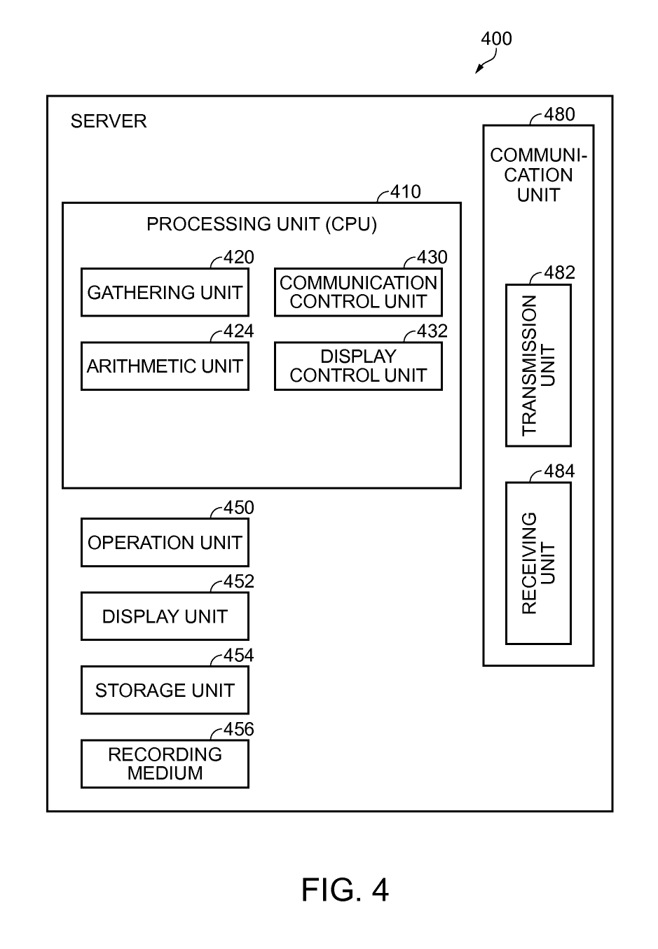

As the server 400 receives this select data and displays the ID number, the vibration data, the date, the time and the position information of the measurement device 300 on map data on a display unit 452 (see FIG. 4), the distribution of a vibration or the like can be estimated.

### Configuration of Server

FIG. 4 shows the configuration of the server of this embodiment.

The server 400 includes a processing unit 410, an operation unit 450, a display unit 452, a storage unit 454, a recording medium 456, and a communication unit 480. The server 400 of this embodiment is an example and a part of the components (respective parts) may be omitted or some components may be added.

The operation unit 450 is an input device made up of operation keys and button switches or the like, and outputs an operation signal to the processing unit 410.

The display unit 452 is a display device made up of an LCD or the like and displays various kinds of information on the basis of a display signal inputted from the processing unit 410.

The storage unit 454 stores programs and data or the like for the processing unit 410 to carry out various kinds of calculation processing and control processing. The storage unit 454 is also used as a work area for the processing unit 410 and used for temporarily storing data inputted from the operation unit 450, programs and data read out from the recording medium 456, the results of arithmetic operations executed by the processing unit 410 according to various programs, and the like. The data stored in the storage unit 454 includes map data (map information).

The recording medium 456 includes an optical disc (CD, DVD), magneto-optical disc (MO), magnetic disc, hard disk, magnetic tape, or memory (ROM, flash memory or the like).

The communication unit 480 includes a transmission unit 482 and a receiving unit 484 and carries out wireless communication with the vibration processing device 100 on the basis of a communication signal inputted from the processing unit 410. While wireless communication is used in this embodiment, wired communication may also be used.

The processing unit 410 includes a gathering unit 420, an arithmetic unit 424, a communication control unit 430, and a display control unit 432, and carries out various kinds of calculations and control processing according to programs stored in the storage unit 454 and the recording medium 456. However, in the processing unit 410 of this embodiment, a part of these units may be omitted or changed, and another component (element) may also be added.

Specifically, the processing unit 410 receives output data or select data from the vibration processing device 100 via the communication unit 480, and carries out various kinds of calculation processing. The processing unit 410 also carries out various kinds of processing according to operation signals from the operation unit 450, and processing to cause the display unit 452 to display various kinds of information, or the like.

The gathering unit 420 carries out processing to acquire the output data or the select data from the vibration processing device 100 via the communication unit 480 and save these data in the storage unit 454 or the recording medium 456.

The arithmetic unit 424 carries out frequency filtering processing on the output data or the select data acquired by the gathering unit 420, and carries out processing to calculate a maximum acceleration, SI (spectrum intensity) value, seismic intensity or the like. Also, the output data or the select data, and the calculated maximum acceleration, SI value, seismic intensity or the like can be displayed on the display unit 452.

The communication control unit 430 carries out processing to control communication carried out by the communication unit 480 with the vibration processing device 100, other communication units (not shown) and other servers (not shown) or the like, connected via wireless communication.

The display control unit 432 carries out processing to control the display on the display unit 452. The display control unit 432 may cause the display unit 452 to display the map data stored in the storage unit 454. Also, as the arithmetic unit 424 carries out an arithmetic operation on the select data gathered from the vibration processing device 100, the distribution of seismic intensity or the like can be displayed on the map data.

### Processing by Vibration Information Gathering Apparatus

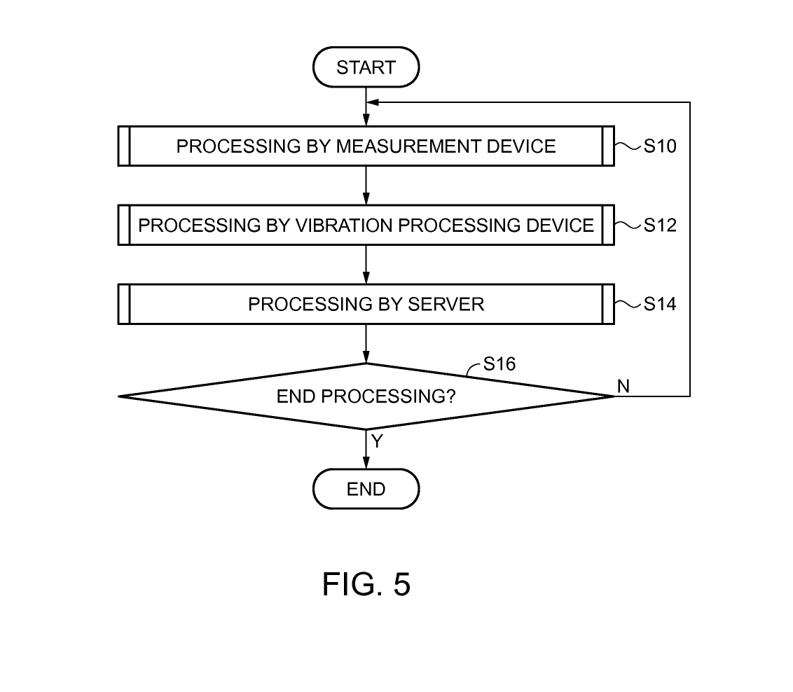

FIG. 5 is a flowchart showing an example of the processing by the vibration information gathering apparatus according to this embodiment.

As shown in FIG. 5, first, processing by the measurement device 300 is carried out (Step S10). Details of this processing by the measurement device 300 in Step S10 will be described later.

Next, processing by the vibration processing device 100 is carried out (Step S12). Details of this processing by the vibration processing device 100 in this Step S12 will be described later.

Then, processing by the server 400 is carried out (Step S14). Details of this processing by the server 400 in Step S14 will be described later.

Next, whether to end the processing by the vibration information gathering apparatus or not is determined (Step S16). If the processing by the vibration information gathering apparatus is not to be ended (N in Step S16), the processing shifts to Step S10 and the processing is repeated. If the processing by the vibration information gathering apparatus is to be ended (Y in Step S16), the processing by the vibration information gathering apparatus ends.

### Processing by Measurement Device

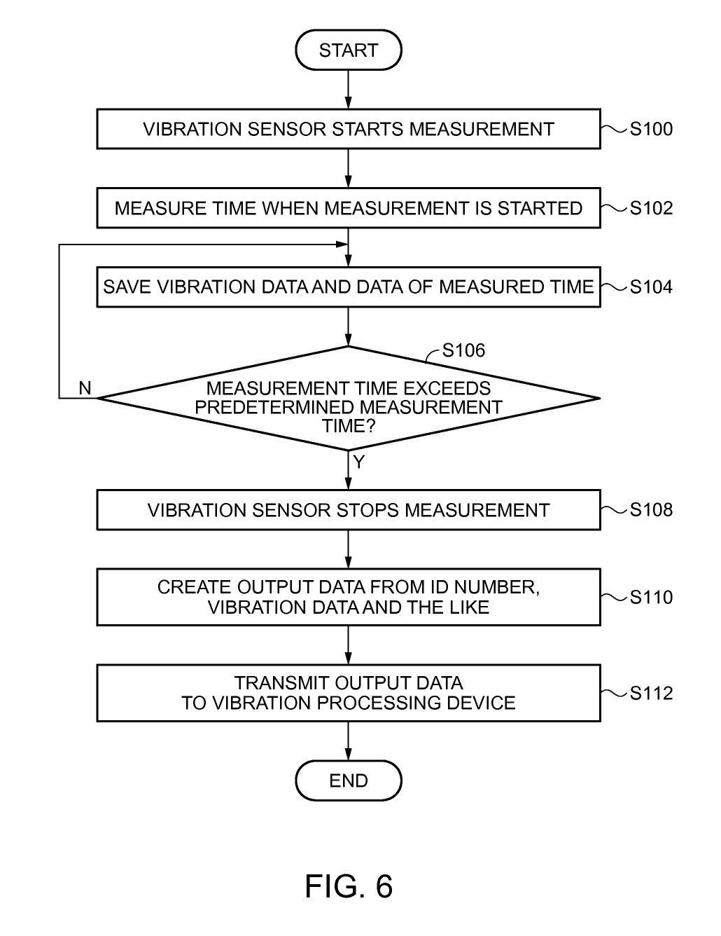

FIG. 6 is a flowchart showing an example of the processing by the measurement device 300 (Step S10 shown in FIG. 5). FIG. 6 will be described below, with reference to FIG. 2.

As shown in FIG. 6, first, the vibration sensor 302 starts measuring a vibration (Step S100).

Next, the clock 362 of the measurement device 300 measures the time when the measurement is started (Step S102).

Then, the gathering unit 320 of the processing unit 310 saves the vibration data measured by the vibration sensor 302, and the data of the time when the measurement is started, which is measured by the clock 362, in one of the gathering unit 320, the storage unit 354, and the recording medium 356 (Step S104).

Next, the gathering unit 320 of the processing unit 310 determines whether the elapsed time from the time when the measurement is started, measured in Step S102, that is, the measurement time during which a vibration are measured, exceeds a predetermined time or not (Step S106).

If the measurement time is equal to or shorter than the predetermined time (N in Step S106), the vibration sensor 302 continues the measurement and the processing shifts to Step S104.

Meanwhile, if the measurement time exceeds the predetermined time (Y in Step S106), the vibration sensor 302 stops the measurement (Step S108).

Next, the selection unit 324 of the processing unit 310 creates output data which includes the ID number added to the measurement device 300, the vibration data saved in Step S104, and the time when the measurement is started, or the like (Step S110).

Then, the communication control unit 330 of the processing unit 310 transmits the output data created in Step S110 to the vibration processing device 100 via the communication unit 380 (Step S112) and the processing ends.

### Processing by Vibration Processing Device

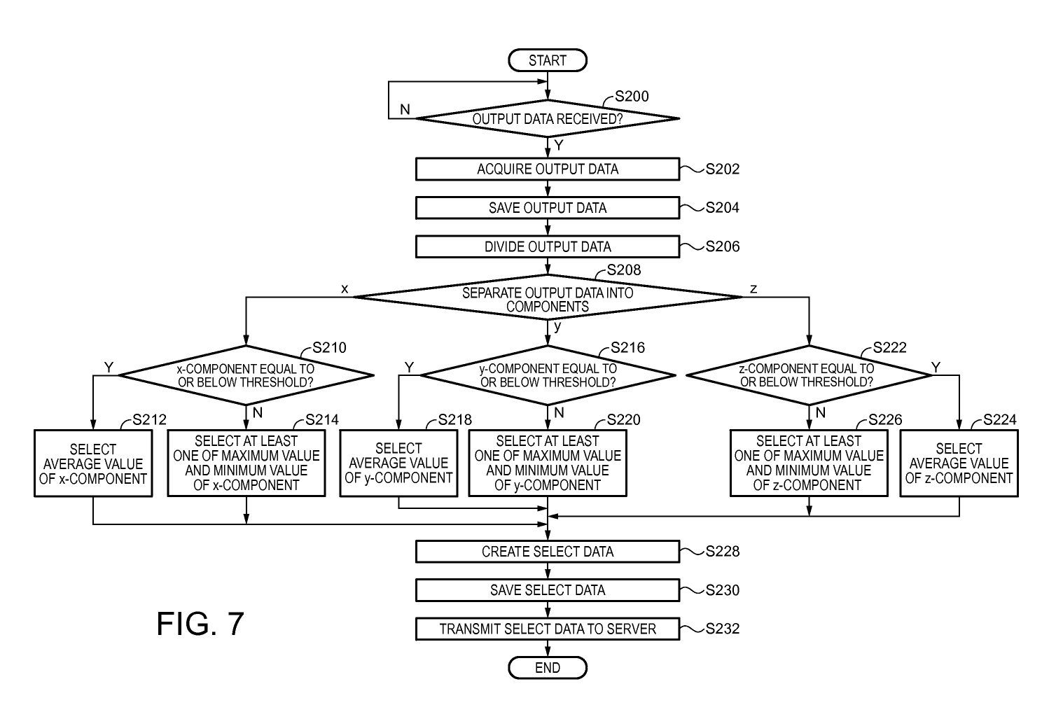

FIG. 7 is a flowchart showing an example of the processing by the vibration processing device 100 (Step S12 shown in FIG. 5).

The gathering unit 120 of the processing unit 110 in the vibration processing device 100 determines whether output data transmitted from the measurement device 300 is received by the receiving unit 184 of the communication unit 180 or not (Step S200). If the output data is not received by the receiving unit 184 (N in Step S200), the determination is repeated. In other words, the receiving unit 184 waits for reception of the output data from the measurement device 300. If the receiving unit 184 detects reception of the output data (Y in Step S200), acquisition of the output data is carried out first (Step S202).

Next, the gathering unit 120 of the processing unit 110 saves the output data in one of the gathering unit 120, the storage unit 154, and the recording medium 156 (Step S204).

Then, the gathering unit 120 of the processing unit 110 divides the vibration data part of the output data into coordinate components (x-axis component, y-axis component, z-axis component) (Step S206).

Next, the selection unit 124 of the processing unit 110 separates the divided vibration data part of the output data into respective coordinate component data (x-axis component, y-axis component, z-axis component) (Step S208).

If the coordinate component is component data of the x-axis component (x in Step S208), the selection unit 124 of the processing unit 110 determines whether the component data of the x-axis component is equal to or below a threshold, or not (Step S210).

If the component data of the x-axis component of the coordinate component is equal to or below the threshold (Y in Step S210), the selection unit 124 of the processing unit 110 calculates an average value of the component data of the x-axis component and selects the average value of the component data (Step S212). The processing then shifts to Step S228.

Meanwhile, if the component data of the x-axis component of the coordinate component exceeds the threshold (N in Step S210), the selection unit 124 of the processing unit 110 selects at least one of a maximum value of the component data of the x-axis component and a minimum value of the component data (Step S214). The processing then shifts to Step S228.

If the coordinate component is component data of the y-axis component (y in Step S208), the selection unit 124 of the processing unit 110 determines whether the component data of the y-axis component is equal to or below a threshold, or not (Step S216).

If the component data of the y-axis component of the coordinate component is equal to or below the threshold (Y in Step S216), the selection unit 124 of the processing unit 110 calculates an average value of the component data of the y-axis component and selects the average value of the component data (Step S218). The processing then shifts to Step S228.

Meanwhile, if the component data of the y-axis component of the coordinate component exceeds the threshold (N in Step S216), the selection unit 124 of the processing unit 110 selects at least one of a maximum value of the component data of the y-axis component and a minimum value of the component data (Step S220). The processing then shifts to Step S228.

If the coordinate component is component data of the z-axis component (z in Step S208), the selection unit 124 of the processing unit 110 determines whether the component data of the z-axis component is equal to or below a threshold, or not (Step S222).

If the component data of the z-axis component of the coordinate component is equal to or below the threshold (Y in Step S222), the selection unit 124 of the processing unit 110 calculates an average value of the component data of the z-axis component and selects the average value of the component data (Step S224). The processing then shifts to Step S228.

Meanwhile, if the component data of the z-axis component of the coordinate component exceeds the threshold (N in Step S222), the selection unit 124 of the processing unit 110 selects at least one of a maximum value of the component data of the z-axis component and a minimum value of the component data (Step S226). The processing then shifts to Step S228.

The selection unit 124 of the processing unit 110 creates select data which includes the ID number and the time when the measurement is started, or the like, using the component data of the coordinate components (x-axis component, y-axis component, z-axis component) selected in the above steps (Step S228).

The gathering unit 120 of the processing unit 110 saves the created select data in one of the storage unit 154 and the recording medium 156 (Step S230).

Next, the communication control unit 130 of the processing unit 110 transmits the select data of the coordinate components (x-axis component, y-axis component, z-axis component) to the server 400 (Step S232), and the processing ends.

### Processing by Server

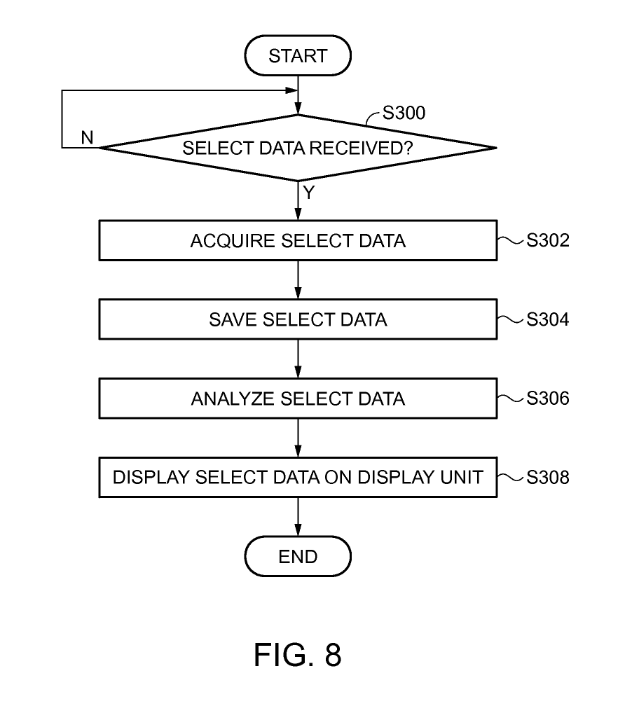

FIG. 8 is a flowchart showing an example of the processing by the server 400 (Step S14 shown in FIG. 5). FIG. 8 will be described hereinafter with reference to FIG. 4.

The gathering unit 420 of the processing unit 410 of the server 400 determines whether select data transmitted from the vibration processing device 100 via the communication network N1 is received by the receiving unit 484 of the communication unit 480 or not (Step S300).

If the select data is not received by the receiving unit 484 (N in Step S300), the determination is repeated. In other words, the receiving unit 484 waits for receiving the select data from the vibration processing device 100. As the receiving unit 484 detects reception of the select data (Y in Step S300), acquisition of the select data is carried out first (Step S302).

Next, the gathering unit 420 of the processing unit 410 saves the select data in one of the gathering unit 420, the storage unit 454, and the recording medium 456 (step S304).

Then, the arithmetic unit 424 of the processing unit 410 analyzes the select data (Step S306).

Next, the display control unit 432 of the processing unit 410 causes the display unit 452 to display the select data analyzed in Step S306 (Step S308) and the processing ends.

As the select data is displayed on the display unit 452, the user can confirm vibration information of the position where the measurement device 300 is provided.

By such processing, the vibration processing device 100 can receive output data measured by and outputted from the measurement device 300 and can create select data selected from the received output data according to a predetermined determination condition and transmit the select data to the server 400 via the communication network N1. For example, the user of the server 400 can estimate the distribution of a vibration by having the status of the measurement device 300 displayed on the map data on the display unit 452 on the basis of the transmitted select data.

As described above, the vibration processing device 100 according to the first embodiment can achieve the following effects.

According to the first embodiment, the vibration processing device 100 receives output data measured by the measurement device 300. Since either the average value of the received output data or at least one of the maximum value of the output data and the minimum value of the output data is selected as select data according to a predetermined determination condition, the data volume can be reduced.

Also, according to the first embodiment, when the vibration processing device 100 receives output data from plural measurement devices 300, creates select data from the plural output data, and transmits the select data to the server 400 via the communication network N1, since the data volume of the select data is smaller than the output data, the load on the communication network N1, straining of the storage unit 454 storing the select data in the server 400, and communication failures due to an increase in the load on the communication network N1 or the like at the time transmitting the select data can be restrained.

Moreover, since the select data is analyzed by the server 400, earthquake information such as seismic intensity at the place where the measurement device 300 is arranged can be acquired. For example, isoseismic lines can be drawn on a map on the basis of the earthquake information and the distribution of seismic intensity can be thus acquired, which is useful for grasping evacuation routes.

Also, with respect to the timing when the select data is transmitted from the vibration processing device 100 to the server 400, for example, in the case where the vibration processing device 100 is installed in a vending machine, the following processing is carried out. If one of the components (x-axis component, y-axis component, z-axis component) of the select data exceeds a threshold, the above timing is not synchronized with the timing when sales data of the vending machine is transmitted to the server 400. If the components of the select data are equal to or below the threshold, the select data may be transmitted at the timing when the vending machine transmits sales data. Thus, if one of the components of the select data exceeds the threshold, urgency is required and therefore it is necessary to transmit the select data quickly to the server 400 and analyze the select data there. If the components of the select data are equal to or below the threshold, communication failures due to an increase in the load on the communication network N1 or the like can be restrained by transmitting the select data at the time of transmitting sales data from the vending machine (regular contact).

### Second Embodiment

### Configuration of Vibration Information Gathering Apparatus

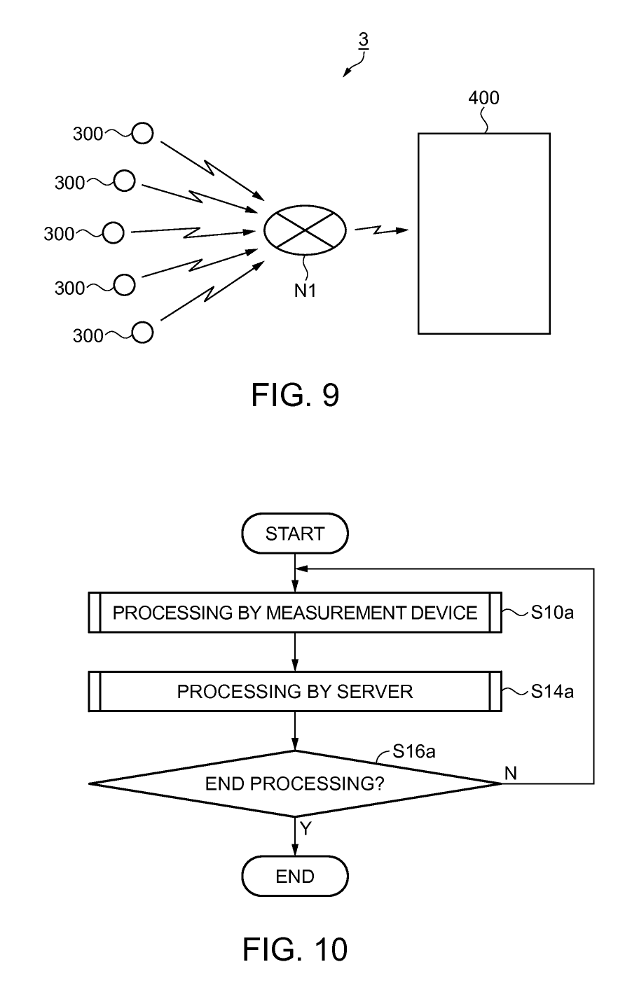

FIG. 9 shows an example of the configuration of a vibration information gathering apparatus 3 according to a second embodiment.

The configuration of the vibration information gathering apparatus 3 according to this embodiment will be described with reference to FIG. 9.

The vibration information gathering apparatus 3 of this embodiment includes plural measurement devices 300, a server 400, and a communication network N1. The measurement devices 300 constantly measure vibration data and transmit data that exceeds a threshold, of outputted data (output data), to the server 400.

The configurations of the measurement devices 300, the server 400 and the communication network N1 in this embodiment are similar to the first embodiment and the measurement devices 300 may be arranged in a structure 10 or plural structures 12. Therefore, these configurations will not be described further.

The plural measurement devices 300 are capable of communicating via a multi-hop wireless network and thus transmitting and receiving data.

The measurement devices 300 transmit output data created from vibration data to the server 400 via the communication network N1. The user of the server 400 can estimate the statue of a vibration measured by the measurement devices 300, for example, by performing arithmetic processing or the like on the received output data.

### Processing by Vibration Information Gathering Apparatus

FIG. 10 is a flowchart showing an example of processing by the vibration information gathering apparatus 3 in this embodiment.

As shown in FIG. 10, first, processing by the measurement device 300 (Step S10a) is carried out. The processing by the measurement device 300 in this Step S10a will be described in detail later.

Next, processing by the server 400 is carried out (Step S14a). The processing by the server 400 in this Step S14a will be described in detail later.

Next, whether to end the processing by the vibration information gathering apparatus or not is determined (Step S16a). If the processing by the vibration information gathering apparatus is not to be ended (N in Step S16a), the processing shifts to Step S10a and the processing is repeated. If the processing by the vibration information gathering apparatus is to be ended (Y in Step S16a), the processing by the vibration information gathering apparatus ends.

### Processing by Measurement Device

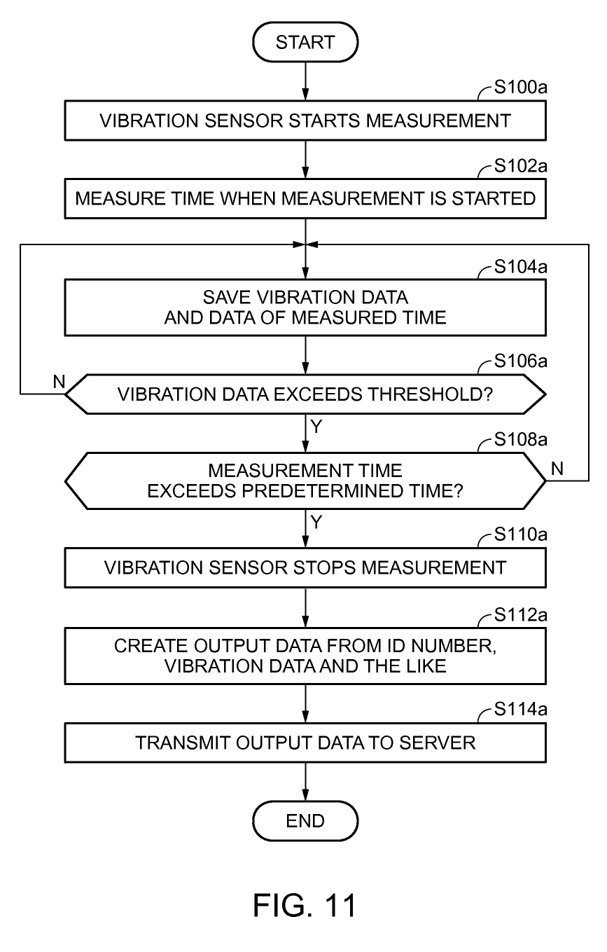

FIG. 11 is a flowchart showing an example of the processing by the measurement device 300 in the second embodiment (Step S10a shown in FIG. 10). FIG. 11 will be described hereinafter with reference to FIG. 2.

As shown in FIG. 11, first, the vibration sensor 302 starts measuring a vibration (Step S100a).

Next, the clock 362 of the measurement device 300 measures the time when the measurement is started (Step S102a).

Then, the gathering unit 320 of the processing unit 310 saves the vibration data measured by the vibration sensor 302, and the data of the time when the measurement is started, which is measured by the clock 362, in one of the gathering unit 320, the storage unit 354, and the recording medium 356 (Step S104a).

Next, the gathering unit 320 of the processing unit 310 determines whether the vibration data measured in Step S100a exceeds a predetermined threshold or not (Step S106a).

If the vibration data is equal to or below the threshold (N in Step S106a), the vibration sensor 302 continues the measurement and the processing shifts to Step S104a.

Meanwhile, if the vibration data exceeds the threshold (Y in Step S106a), it is determined whether the elapsed time from the time when the measurement is started, measured in Step S102a, that is, the measurement time during which a vibration are measured, exceeds a predetermined time or not (Step S108a).

If the measurement time is equal to or shorter than the predetermined time (N in Step S108a), the vibration sensor 302 continues the measurement and the processing shifts to Step S104a.

Meanwhile, if the measurement time exceeds the predetermined time (Y in Step S108a), the vibration sensor 302 stops the measurement (Step S110a).

Next, the selection unit 324 of the processing unit 310 creates output data which includes the ID number added to the measurement device 300, the vibration data saved in Step S104a, and the time when the measurement is started, or the like (Step S112a).

Then, the communication control unit 330 of the processing unit 310 transmits the output data created in Step S112a to the server 400 via the communication unit 380 (Step S114a) and the processing ends.

### Processing by Server

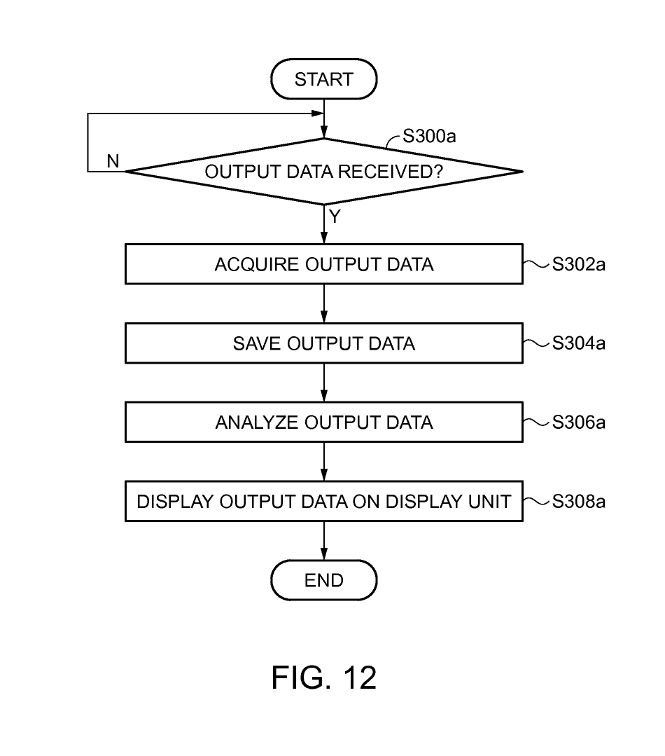

FIG. 12 is a flowchart showing an example of the processing by the server 400 (Step S14a shown in FIG. 10). FIG. 12 will be described hereinafter with reference to FIG. 4.

The gathering unit 420 of the processing unit 410 of the server 400 determines whether output data transmitted from the measurement device 300 via the communication network N1 is received by the receiving unit 484 of the communication unit 480 or not (Step S300a).

If the output data is not received by the receiving unit 484 (N in Step S300a), the determination is repeated. In other words, the receiving unit 484 waits for receiving the output data from the measurement device 300. As the receiving unit 484 detects reception of the output data (Y in Step S300a), acquisition of the output data is carried out first (Step S302a).

Next, the gathering unit 420 of the processing unit 410 saves the output data in one of the gathering unit 420, the storage unit 454, and the recording medium 456 (step S304a).

Then, the arithmetic unit 424 of the processing unit 410 analyzes the output data (Step S306a).

Next, the display control unit 432 of the processing unit 410 causes the display unit 452 to display the output data analyzed in Step S306a (Step S308a) and the processing ends.

As the output data is displayed on the display unit 452, the user of the server 400 can confirm vibration information of the position where the measurement device 300 is provided.

By such processing, the measurement device 300 can create output data and transmit the output data to the server 400 via the communication network N1, if vibration data measured by the measurement device 300 exceeds a threshold.

The user of the server 400 can estimate the status of the measurement device 300, for example, by performing arithmetic processing or the like on the received output data.

As described above, the vibration information gathering apparatus 3 according to the second embodiment can achieve the following effects in addition to the effects of the first embodiment.

According to the second embodiment, in the vibration information gathering apparatus 3, the measurement devices 300 are arranged at plural places and each measurement device 300 is connected to the server 400. Therefore, for example, even if some of the measurement devices 300 cannot connect to the server 400 when an earthquake occurs, the connected measurement devices 300 can create output data and each of these measurement devices 300 can transmit vibration data to the server 400 via the communication network N1. Thus, when an earthquake occurs, output data can be quickly transmitted to the server 400 and isoseismic lines can be drawn on a map on the basis of earthquake information so that the distribution of seismic intensity can be acquired, which is useful for grasping evacuation routes in case of disaster.

Also, in the vibration information gathering apparatus 3, since the measurement devices 300 selectively transmit output data in which vibration data exceeds a threshold, the data volume to be transmitted can be reduced, compared with a vibration information gathering apparatus that constantly measures a vibration. As the data volume to be transmitted is reduced, the load on the communication network N1, straining of the storage unit 454 in the server 400, and communication failures due to an increase in the load on the communication network N1 or the like at the time transmitting the output data can be restrained.

### Third Embodiment

### Configuration of Vibration Information Gathering Apparatus

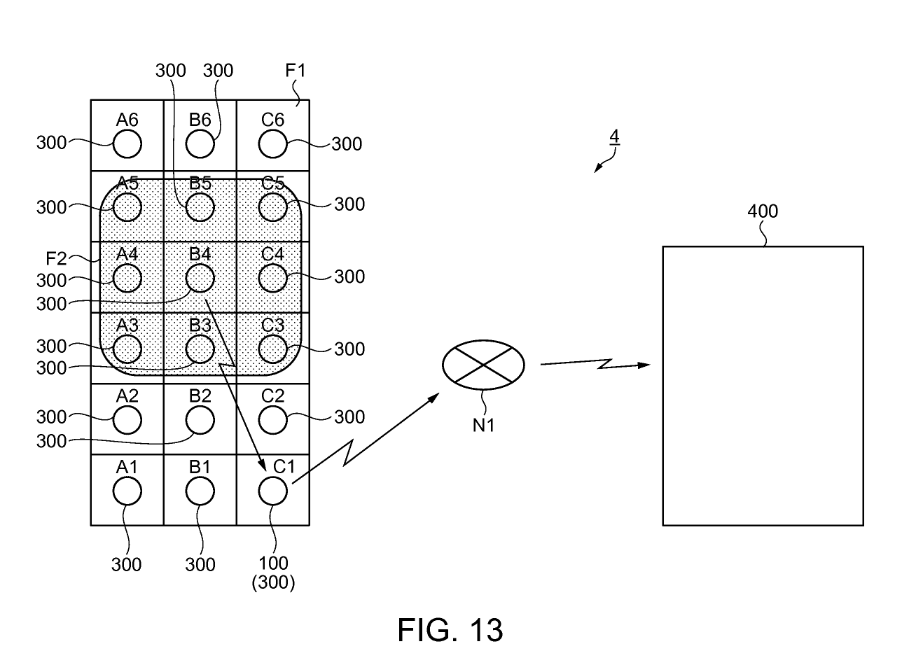

FIG. 13 shows an example of the configuration of a vibration information gathering apparatus according to this embodiment.

The configuration of a vibration information gathering apparatus 4 according to this embodiment will be described with reference to FIG. 13.

The vibration information gathering apparatus 4 in this embodiment includes a vibration processing device 100, plural measurement devices 300, a server 400, a structure F1, an integrated area F2, and a communication network N1.

The vibration processing device 100 and the measurement devices 300 arranged in the structure F1 constantly measure a vibration and output plural output data. Integrated data is created from the output data from the measurement devices 300 and the vibration processing device 100 that are set in the integrated area F2 according to a predetermined threshold. Select data selected from the integrated data by the processing unit 110 of the vibration processing device 100 is transmitted to the server 400.

The configurations of the vibration processing device 100, the measurement devices 300, the server 400 and the communication network N1 in this embodiment are similar to the first embodiment and therefore will not be described further.

The vibration processing device 100 and the plural measurement devices 300 are capable of communicating via a multi-hop wireless network and thus transmitting and receiving data.

In the vibration information gathering apparatus 4 of this embodiment, the plural measurement devices 300 and the vibration processing device 100 are arranged at plural places in the structure F1, as shown in FIG. 13. Here, the structure F1 is a high-rise building or super high-rise building.

In the integrated area F2, the difference between the output data outputted from the vibration processing device 100 and each of the plural measurement devices 300 is calculated, and the vibration processing device 100 and the measurement devices 300 outputting output data in which the difference is equal to or below a predetermined threshold set by the user or the like are set.

The gathering units 120, 320 of the vibration processing device 100 and the plural measurement devices 300 arranged in the structure F1 acquire vibration data from the vibration sensors 102, 302 and create output data from the ID number, the vibration data and the like.

The vibration processing device 100 and the measurement devices 300 transmit and receive the output data to each of the vibration processing device 100 and measurement devices 300, using the communication units 180, 380.

Of the vibration processing device 100 and the measurement devices 300, the vibration processing device 100 and the measurement devices 300 outputting the output data in which the calculated difference of output data is equal to or below a predetermined threshold are set in the integrated area F2.

The output data from the vibration processing device 100 and the measurement devices 300 set in the integrated area F2 is averaged, and the vibration processing device 100 or the measurement device 300 outputting output data that approximates the average value is selected. The selected vibration processing device 100 or measurement device 300 creates integrated data from the output data or the like.

The created integrated data is transmitted to the processing unit 110 of the vibration processing device 100. The vibration processing device 100 creates select data from the integrated data and transmits the select data to the server 400 via the communication network N1.

The user of the server 400 can estimate the status of the measurement devices 300 and the vibration processing device 100, for example, by carrying out arithmetic processing or the like on the received select data.

The detailed content of the integrated data will be described later.

Although not described in detail, the vibration data and the output data are saved in the gathering units (120, 320), the storage units (154, 354) and the recording media (156, 356) of the vibration processing device 100 and the measurement devices 300, and the select data is saved in the gathering units (120, 420), the storage units (154, 454) and the recording media (156, 456) of the vibration processing device 100 and the server 400.

In the vibration information gathering apparatus 4 of this embodiment, the vibration processing device 100 and the plural measurement devices 300 are arranged in the structure F1, with ID numbers A1 to A6, ID numbers B1 to B6, and ID numbers C1 to C6 allocated to these devices, as shown in FIG. 13.

As the vibration processing device 100 and the plural measurement devices 300 are arranged in the structure F1, a vibration of the structure F1 can be measured in detail. For example, how a vibration generated by an earthquake influence the structure F1 can be measured by the vibration processing device 100 and the plural measurement devices 300, and the result thus acquired can be used to analyze the construction of the structure F1.

Hereinafter, details of the vibration information gathering apparatus 4 of this embodiment will be described.

If the vibration processing device 100 functions similarly to a measurement device 300, the measurement device 300 will be taken up as an example in the description.

The vibration sensor 302 of the measurement device 300 (ID numbers A1 to A6, ID numbers B1 to B6, ID numbers C1 to C6) arranged in the structure F1 measures a vibration. The gathering unit 320 acquires vibration data from the vibration sensor and creates output data from the ID number, the vibration data and the like.

The measurement device 300 transmits and receives output data to and from the other measurement devices 300, using the communication unit 380. The gathering unit 320 of each measurement device 300 calculates the difference between the output data that is outputted and the other output data that is received. If the difference between the output data that is outputted and the other output data that is received is equal to or below a threshold as a result of the calculation, the measurement device 300 that outputs the output data equal to or below the threshold is set in the integrated area F2 (hatched part in FIG. 13). In this embodiment, the measurement devices 300 (ID numbers A3, A4, A5, B3, B4, B5, C3, C4, C5) are set in the integrated area F2.

Each of the measurement devices 300 set in the integrated area F2 calculates an average value of the output data from all the measurement devices 300 that are set there, and selects the measurement device 300 outputting the output data that approximates the average value. In this embodiment, the measurement device 300 (ID number B4) is selected.

The selected measurement device 300 (ID number B4) creates integrated data from the output data and the like and transmits the integrated data to the vibration processing device 100 (ID number C1). The vibration processing device 100 (ID number C1) creates select data from the received integrated data and transmits the select data to the server 400.

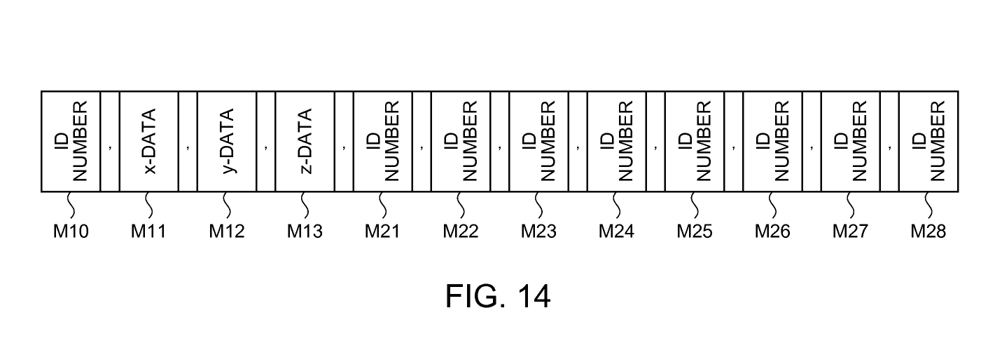

Now, an example of the integrated data outputted from the measurement device 300 in the integrated area F2 will be described with reference to FIG. 14.

As shown in FIG. 14, the integrated data outputted from the measurement device 300 in the integrated area F2 includes an ID number M10 selected from the integrated area F2, x-data M11, y-data M12, z-data M13, and ID numbers M21 to M28 of the measurement devices 300 in the integrated area F2.

The ID number M10 is the ID number of the measurement device 300 selected in the integrated area F2.

The x-data M11, y-data M12 and z-data M13 are the output data from the measurement device 300 (ID number M10) selected in the integrated area F2.

The ID numbers M21 to M28 are the ID numbers of the measurement devices 300 included in the integrated area F2 (excluding the measurement device 300 with the ID number M10).

Thus, the integrated data indicates the measurement device 300 (ID number M10) that represents the integrated area F2, and the output data (x-data M11, y-data M12, z-data M13). The other ID numbers M21 to M28 indicate the measurement devices 300 outputting output data with smaller differences from the representative data. That is, the integrated data indicates the plural output data that is made uniform in the integrated area F2 and the ID numbers set in the integrated area F2.

Thus, the other data than the output data from the representative measurement device 300 can be reduced.

Also, if the output data from the plural measurement devices 300 included in the integrated area F2 is equal to or below a threshold, for example, over a predetermined period, the same output data is used and transmitted as the integrated data in the integrated area F2 to the vibration processing device 100.

As a specific example, the measurement devices 300 included in the integrated area F2 measure a vibration at 1-minute intervals and thus acquire output data. If the output data is equal to or below a threshold for 60 minutes, the measurement devices 300 use the output data as integrated data in the integrated area F2 and transmit the same integrated data to the vibration processing device 100 for 60 minutes.

Thus, since the measurement devices 300 transmit the same integrated data to the vibration processing device 100, the integrated data to be saved in the storage unit 154 (not shown) of the vibration processing device 100 can be reduced.

As described above, the vibration information gathering apparatus 4 according to the third embodiment can achieve the following effects in addition to the effects of the first embodiment.

According to the third embodiment, the vibration processing device 100 receives integrated data from the selected measurement devices 300 from the integrated area F2 in the structure F1 and creates select data. The vibration processing device 100 also transmits the select data to the server 400 via the communication network N1. The user of the server 400 can estimate the status of the measurement devices 300 and the vibration processing device 100, for example, by performing arithmetic processing or the like on the received select data.

Moreover, in the vibration information gathering apparatus 4, since output data that approximates the average value of the output data outputted from the measurement devices 300 in the integrated area F2 is transmitted as integrated data, the data volume to be transmitted can be reduced, compared with a vibration information gathering apparatus that constantly measures a vibration. As the data to be transmitted is reduced, the load on the communication network N1, straining of the storage unit 454 storing the select data in the server 400, and communication failures due to an increase in the load on the communication network N1 or the like at the time of transmitting the select data can be restrained.

### Vibration Sensor

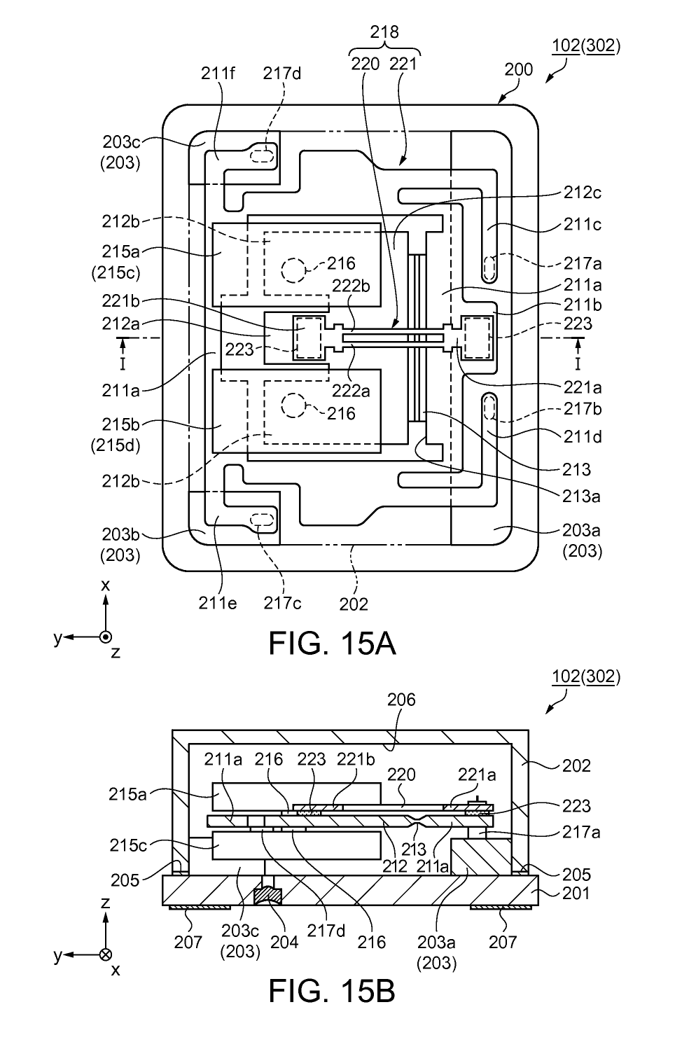

FIG. 15A is a plan view showing the configuration of the vibration sensor 102 (vibration sensor 302) according to this embodiment. FIG. 15B is a cross-sectional view showing the configuration of a physical quantity detection device, showing a cross section taken along the line I-I in FIG. 15A. In FIGS. 15A and 15B, x-axis, y-axis and z-axis are illustrated as three axes that are orthogonal to each other. For convenience of explanation, a lid 202 is not shown in the plan view.

As shown in FIGS. 15A and 15B, the vibration sensor 102 (vibration sensor 302) has a package 200, and a physical quantity detection sensor 218 including an element base body 221 and a pressure-sensitive element 220.

First, the package 200 is formed by a package base 201 and a lid 202. The package base 201 is a flat plate that is quadrilateral in a plan view as viewed from the z-axis direction.

The package base 201 has step sections 203 to fix the element base body 221 of the physical quantity detection sensor 218. The step sections 203 include a step section 203a provided along the x-axis at one end in the y-axis direction, and step sections 203b, 203c provided respectively near two corner parts at the other end in the y-axis direction.

The package base 201 also has a sealing section 204 made up of a hole penetrating the flat plate and a sealing member to close the hole, and an external terminal 207 that is formed on a surface opposite to the surface where the step sections 203a, 203b, 203c are provided and that is configured to connect to an external oscillation circuit or the like.

The package base 201 is made from an aluminum oxide sintered body produced by burning a ceramic green sheet. An aluminum oxide sintered body of a ceramic is a material that is excellent for the use as a package but difficult to process. However, in this case, the package base 201 is in the shape of a flat plate and therefore can be formed more easily than in the case where the package base 201 is formed in other shapes than a flat plate. The package base 201 can also be formed, using materials such as crystal, glass, and silicon or the like.

The lid 202 has a housing section 206 that is formed in a concave shape on the inner side. The lid 202 is arranged to cover the pressure-sensitive element 220, with the step sections 203a, 203b, 203c in the package base 201 serving as guides, and the lid 202 is thus fixed to the package base 201.

The lid 202 can use the same material as the package base 201 or metals such as Kovar and stainless steel, or the like. Here, Kovar is used, which enables the housing section 206 to be formed more easily than with a ceramic. As the lid 202 is joined to the package base 201 via a seam ring 205, the housing section 206 can be sealed in a depressurized airtight state or the like.

Here, the sealing of the housing section 206 is carried out by a method in which, after the package base 201 and the lid 202 are joined together, the air inside the housing section 206 is let out through the hole of the sealing section 204 to depressurize the housing section 206 and then the hole is closed with a brazing filler (sealing member). Thus, the physical quantity detection sensor 218 is enclosed in the housing section 206 in the depressurized airtight state. The inside of the housing section 206 may be filled with an inert gas such as nitrogen, helium, or argon.

The physical quantity detection sensor 218 has the element base body 221 that is fixed to the package base 201, and the pressure-sensitive element 220 that is fixed to the element base body 221 and configured to detect a physical quantity, for example, a vibration. The element base body 221 is formed by etching or the like of a crystal plate and is in the form of a plate situated along an x-y plane. The element base body 221 has a fixed section (base section) 211 (211a to 211f) that is substantially quadrilateral ring-shaped as viewed in a plan view, a movable section 212 (212a to 212c) arranged on the inner side of the fixed section 211 (inside the ring-shape), and a joint section 213 connecting the fixed section 211 and the movable section 212 together.

The fixed section 211 has a frame section 211a formed in a ring-shape along the x-axis and the y-axis, an element placing section 211b protruding outward along the y-axis from the center of one side of the frame section 211a along the x-axis, an arm section 211c diverging from one side of the frame section 211a along the y-axis and extending to the vicinity of the element placing section 211b along the outer periphery of the frame section 211a, an arm section 211d diverging from the other side of the frame section 211a along the y-axis and extending to the vicinity of the element placing section 211b along the outer periphery of the frame section 211a, an arm section 211e diverging from one end on the other side of the frame section 211a along the x-axis and extending to the vicinity of the diverging point of the arm section 211d along the outer periphery of the frame section 211a, and an arm section 211f diverging from the other end on the other side of the frame section 211a along the x-axis and extending to the vicinity of the diverging point of the arm section 211c along the outer periphery of the frame section 211a.

The arm sections 211c, 211d, 211e, 211f are sites to fix the element base body 221 to the package base 201. A distal end part of the arm section 211c is fixed to the step section 203a via a supporting section 217 (217a) (FIGS. 15A and 15B). A distal end part of the arm section 211d is fixed to the step section 203a via a supporting section 217 (217b). A distal end part of the arm section 211e is fixed to the step section 203b via a supporting section 217 (217c). A distal end part of the arm section 211f is fixed to the step section 203c via a supporting section 217 (217d). The supporting sections 217 in this case are adhesives, which fix the entire fixed section 211 to the step sections 203 with a predetermined spacing provided via the arm sections 211c, 211d, 211e, 211f.

The movable section 212 is surrounded by the frame section 211a and connected to the frame section 211a on which the element placing section 211b is formed, via the joint section 213. That is, the movable section 212 is cantilevered on the frame section 211a via the joint section 213. The movable section 212 has an element placing section 212a extending along the y-axis in the direction opposite to the joint section 213, and mass body placing sections 212b provided on both sides of the element placing section 212a and extending respectively along the y-axis. Here, the surface on the side where the pressure-sensitive element 220 is provided, in the movable section 212, is referred to as a main surface 212c.

The mass body placing sections 212b of the movable section 212 are provided with mass bodies 215 which function as weights. The mass bodies 215 (215a to 215d) include a mass body 215a provided on the side of the main surface 212c of one mass body placing section 212b, a mass body 215c provided on the surface on the opposite side to the main surface 212c so as to overlap with the mass body 215a as viewed in a plan view, a mass body 215b provided on the side of the main surface 212c of the other mass body placing section 212b, and a mass body 215d provided on the surface on the opposite side to the main surface 212c so as to overlap with the mass body 215b as viewed in a plan view. These mass bodies 215 are fixed to the movable section 212 via joining sections 216. The joining sections 216 in this case are adhesives provided at the positions of the centers of gravity of the mass bodies 215 and fix the mass bodies 215 and the movable section 212 together with a predetermined spacing.

The pressure-sensitive element 220 has a base section 221a fixed to the element placing section 211b of the fixed section 211 with an adhesive 223, a base section 221b fixed to the element placing section 212a of the movable section 212 with an adhesive 223, and vibration beam sections 222 (222a, 222b) arranged between the base section 221a and the base section 221b and configured to detect a physical quantity. That is, the pressure-sensitive element 220 is connected to the fixed section (base section) 211 and the movable section 212 and arranged to cross over the joint section 213. In this case, the vibration beam sections 222 are in a rectangular columnar shape, and as a drive signal (AC voltage) is applied to excitation electrodes (not shown) provided on the respective vibration beam sections 222a, 222b, the vibration beam sections 222a, 222b bend and vibrate toward and away from each other along the x-axis. The excitation electrodes are electrically connected to the external terminal 207 via a wire, not shown, for the application of the drive signal.

The pressure-sensitive element 220 is formed by patterning, with a photolithography technique and an etching technique, a crystal substrate sliced out from a crystal ore or the like at a predetermined angle. By thus forming the pressure-sensitive element 220 with the material of the same quality as the element base body 221, it is possible to reduce the difference in the coefficient of linear expansion between the pressure-sensitive element 220 and the element base body 221, which is preferable. This also applies to the case where the pressure-sensitive element 220 and the element base body 221 are formed with other materials than crystal.

Next, the operation of the physical quantity detection sensor 218 will be described. As shown in FIG. 15B, if a physical quantity such as a vibration is applied to the physical quantity detection sensor 218, for example, in the +z direction (direction intersecting with the main surface 212c), a force in the −z direction acts on the movable section 212 and displaces the movable section 212 in the −z direction about the joint section 213 as a support. Thus, a force in the direction in which the base section 221a and the base section 221b move away from each other along the y-axis is applied to the pressure-sensitive element 220, and tensile stress is generated in the vibration beam sections 222 of the pressure-sensitive element 220. Therefore, the resonance frequency of the vibration beam sections 222, that is, the frequency at which the vibration beam sections 222 vibrate, becomes higher.

Meanwhile, if a physical quantity such as a vibration is applied to the physical quantity detection sensor 218, for example, in the −z direction (direction intersecting with the main surface 212c), a force in the +z direction acts on the movable section 212 and displaces the movable section 212 in the +z direction about the joint section 213 as a support. Thus, a force in the direction in which the base section 221a and the base section 221b move toward each other along the y-axis is applied to the pressure-sensitive element 220, and compressive stress is generated in the vibration beam sections 222 of the pressure-sensitive element 220. Therefore, resonance frequency of the vibration beam sections 222 becomes lower.

### Examples

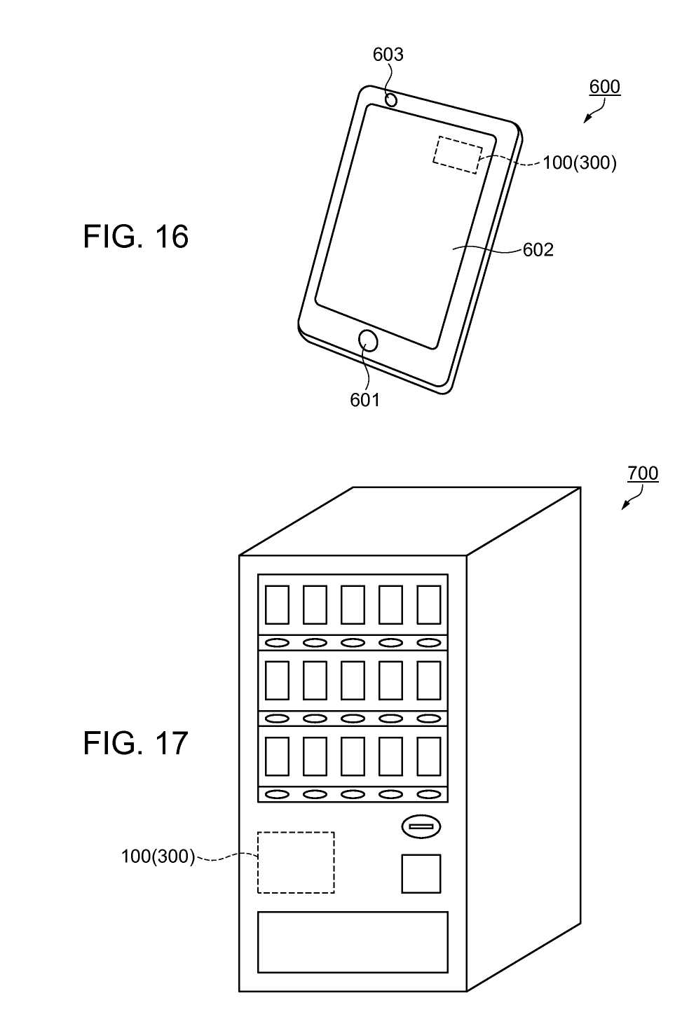

Next, examples of application of the vibration information gathering apparatus 2 according to an embodiment of the invention will be described with reference to FIGS. 16 and 17.

FIG. 16 is a perspective view showing a mobile phone that is an electronic device equipped with the vibration processing device 100 (measurement device 300). FIG. 17 is a perspective view showing a vending machine equipped with the vibration processing device 100 (measurement device 300).

### Electronic Device

As shown in FIG. 16, a mobile phone 600 as an electronic device is equipped with the vibration processing device 100 or the measurement device 300 according to the embodiment.

The mobile phone 600 shown in FIG. 16 is a smartphone type, as an example. The mobile phone 600 is equipped with an operation button 601, a display unit 602 and a camera mechanism 603, and functions as a telephone unit and camera. The mobile phone 600 is equipped with the vibration processing device 100 (measurement device 300) and measures a vibration, for example, when an earthquake happens, and transmits the measured vibration information to a server or the like (not shown), using a wireless communication unit (not shown) of the mobile phone, thus enabling the vibration information to be gathered at the server quickly.

The mobile phone 600 is equipped with the vibration processing device 100 (measurement device 300) and therefore can acquire measured vibration data. If such mobile phones 600 are arranged, for example, in a broad range or at a high density, the accuracy with which a vibration are measured can be improved.

### Vending Machine

As shown in FIG. 17, a vending machine 700 is equipped with the vibration processing device 100 or the measurement device 300.

In the vending machine 700, as the vibration processing device 100 (measurement device 300) measures a vibration, the vibration status or the like in the place where the vending machine 700 is arranged can be grasped and seismic intensities or the like of an earthquake can be accurately measured. Also, if the vending machine 700 is arranged at plural sites in a structure or the like so as to measure a vibration of the structure and analyze the result of the measurement, the analysis can be used for structural health monitoring (SHM) and the health and capability of the structure can be securely monitored.

In such a vending machine 700, for example, a point of sales (POS) system for grasping sales information (not shown) is introduced, and output data or select data from the vibration processing device 100 (measurement device 300) can be transmitted to the server 400 (not shown), using the communication network of the POS system or a wireless communication unit (not shown) provided in the vending machine 700. Also, since a large number of vending machines are arranged (about 5 million (in Japan) according to the 2012 survey by Japan Vending Machine Manufacturers Association), it is possible to measure a vibration in a broad range and at a high density, for example, by installing the vibration processing device 100 (measurement device 300) in the vending machines 700.

Moreover, the vibration processing device 100 (measurement device 300) can be installed in fixed devices such as hydrants, traffic signals, utility poles, telephone poles, and gas meters having a wireless communication unit, other than the above electronic device and vending machine, and can be applied in a broad range of fields.

In the case where the measurement device 300 (vibration processing device 100) is installed in the above vending machine, when a disaster such as an earthquake happens, attention can be drawn with display of information on the display unit 152 (display unit 352) (see FIG. 2) or audio data from the audio input/output unit 166 (audio input/output unit 366), by remote control from the server 400 via the communication network N1 (see FIGS. 1A and 1B). In the case of a vending machine that sells beverages, the vending machine can provide beverages gratis as a so-called emergency beverage providing vendor.

In the case where a thermometer-hygrometer (not shown) is installed in the vending machine, when a condition that tends to cause heatstroke is met on the basis of a predetermined correlation between measured temperature and humidity, attention can be drawn with respect to prevention of heatstroke and the like by utilizing display on the display unit 152 (display unit 352) or audio data from the audio input/output unit 166 (audio input/output unit 366). Also, attention can be drawn with respect to heat by displaying a “high temperature warning” issued by Japan Meteorological Agency or a “wet bulb globe temperature (WBGT)” issued by the Ministry of the Environment, on the display unit 152 (display unit 352), or by utilizing audio data from the audio input/output unit 166 (audio input/output unit 366), by remote control from the server 400 via the communication network N1.

The entire disclosure of Japanese Patent Application No. 2013-238590, filed Nov. 19, 2013 is expressly incorporated by reference herein.

What is claimed is:

1. A vibration information gathering method comprising:
gathering output data about information of a vibration of a structure; and
selecting at least one of an average value, a maximum value and a minimum value from the output data that is gathered.

2. The vibration information gathering method according to claim 1, wherein the selecting of the output data includes calculating an average value of the output data and selecting the average value that is calculated, if the output data that is gathered is equal to or below a threshold.

3. The vibration information gathering method according to claim 1, wherein the selecting of the output data includes selecting one of a maximum value and a minimum value of the output data if the output data that is gathered exceeds the threshold.

4. The vibration information gathering method according to claim 1, wherein the output data includes data measured on plural detection axes, and
the method includes the selecting of the output data on the plural detection axes.

5. The vibration information gathering method according to claim 1, comprising transmitting the output data that is selected, to a server.

6. The vibration information gathering method according to claim 5, comprising transmitting other information than the output data to the server,
wherein the selected output data is transmitted at timing of the transmission.

7. The vibration information gathering method according to claim 5, wherein the output data transmitted to the server includes identification information provided for a measurement device.

8. The vibration information gathering method according to claim 1, wherein the structure is a building, a measurement device which measures a vibration is arranged in the building, and output data from the measurement device is gathered.

9. A vibration information gathering apparatus comprising:
a receiving unit which gathers output data about information of a vibration of a structure; and
a selection unit which selects at least one of an average value, a maximum value and a minimum value of the output data on the basis of a determination condition.

10. The vibration information gathering apparatus according to claim 9, including a measurement device which is provided in a structure and measures a vibration of the structure.

11. The vibration information gathering apparatus according to claim 9, comprising a transmission unit which transmits the output data that is selected, to a server.
